(19) United States
(12) Patent Application Publication
(10) Pub. No.: US 2007/0125306 A1
(43) Pub. Date: Jun. 7, 2007

(54) System for preventing access to a device by an unwanted animal and method of altering an animal's behavior

(76) Inventor: Brian T. Beecher, Sarasota, FL (US)

Correspondence Address: SEYFARTH SHAW LLP, 131 S. DEARBORN ST., SUITE2400, CHICAGO, IL, 60603-5803, US

(21) Appl. No.: 11/293,928

(22) Filed: Dec. 5, 2005

(51) Int. Cl. A01K 5/02; A01K 15/02

(52) U.S. Cl. 119/51.02; 119/61.5

(57) ABSTRACT

A system for preventing access by an unwanted animal is provided which includes a device having a cover, a motor, a sensor and a transmitter worn by the unwanted animal. Upon receiving the signal from the transmitter that the unwanted animal is in close proximity to the device, the sensor activates the motor in order to provide the cover in a closed condition that will prevent the unwanted animal from accessing the device. After the unwanted animal departs the area, the motor will activate in order to allow the cover to return to its open condition so that a wanted animal may have access to the device. The device may provide cues such as visual or audible cues that will train the unwanted animal not to approach the device.

The present invention relates to a system for preventing access to a device by an unwanted animal and allowing access by a wanted animal to the device and a method of altering an animal's behavior. The present invention is applicable to animal feeding devices and litter boxes and the like.

### BACKGROUND

The present invention pertains to devices for animals and the use of such devices in order to control the behavior of animals or pets. Feeding devices and litter boxes are well-known for animals and pets. For example, there are known feeding devices that provide for automatic systems to feed an animal based on a timer or the presence of the animal. In particular, devices may disburse food from a machine upon the presence of a pet in the vicinity of the machine. Also, devices are known that have a platform upon which a pet stands and based on the weight of the pet on the platform access to the food will be provided. The main function of these systems is to allow access; triggered by the wanted pet. In other words, the pet that is supposed to eat the food is the one that actuates the system in order to allow access for that particular pet. Such systems actually have the unintended result of scaring away the wanted pet due to the noise or operation of the machine when the wanted pet is present. None of these systems provide a mechanism in order to prevent access to a device by an unwanted pet, based on the presence of the unwanted pet.

Some systems are known that repel a pet such, as a mat that includes an antenna for receiving a signal from a receiver carried by a pet. Upon stepping on the mat by the pet the receiver on the pet's collar will be activated and provide an electric shock to the pet. While this system does interact with the unwanted pet, it does not provide for an actuation means for the device and does not prevent the unwanted animal from accessing the device.

Therefore, there is desired a system for preventing access to a device by an unwanted animal and a system that allows access by a wanted animal to the device. Such a system could greatly benefit pet owners who have multiple pets in their homes that have differing diets. Such a system could also benefit pets who have eating disorders; for whom the constant visibility of the food for the correct animal would be enhanced by such a device that covers the food only upon the presence of the unwanted pet.

There is desired a device that can teach animals to eat only out of their own food dish. This helps pet owners to keep their pets from eating food that is not meant for them. Many pet owners have multiple pets and they have problems teaching their pets to only eat their own food. For example, dogs love to eat cat food, so for a pet owner to teach their dog not to eat the cat food would require a large amount of time. But the present invention allows the pet owner to discipline the unwanted animal (e.g. the dog, in this example) without having to monitor the dog or food dish. Previously, an individual person would have to be on hand to train the pet. However, the present invention is always activated when the unwanted behavior occurs and the present invention provides a consistent message or cue to train the animal. For example, many pet owners are not completely consistent in teaching their pets and will sometimes allow the animal to continue with the behavior that needs to be prevented. Such inconsistent cues send mixed messages to the animal and makes it difficult to change the animal's behavior. After using the present invention for a short time, pet owners will be able to leave a food dish on the floor and not worry about the unwanted pet eating out of the wrong dish.

The present invention is not meant to solely protect or guard the food in a pet's dish. Protecting or guarding the food does not instill any behavioral changes in an animal. Solely protecting the food prevents the food from being eaten by another animal, but does not provide a cue along with the boundary. This distinction is illustrated by explaining the difference between an electric fence and a leash used for pets. The electric fence allows the animal to go beyond the borders of the yard, but delivers a shock or consequence based on that animal's unwanted action (i.e. leaving the yard). Over time, the animal will not test the borders of the yard due to the training aspect that the shock (cue) provides. If the electric fence is turned off after a training period, the animal will stay in the yard. But if a animal is let off its leash, which has no consistent cue that tells the animal exactly the extent of its behavior that is unwanted the animal will run away.

The behavior modification approach of the present invention makes the animal happier because it will be allowed to make its own choices. After using the present invention, the pet will be trained that it is not supposed to be eating out of the other pets dish due to the cue that the invention provides. The present invention allows an animal to relax and can also change the pets behavior so that it will not be obsessed with food.

The prior art pet devices require the correct animal to learn where his or her food is or how to activate their dish to open it. These are great disadvantages because it is difficult for pets to accomplish such skills. The present invention overcomes these disadvantages and allows pet owners to have the food dish open at all times. Present devices also are inadequate because the requirement of having to open the food dish when the wanted or correct animal is present. Such opening movement of the dish and the motor noise caused by the dish can act to scare the pet and for example, may cause a cat to be scared and jump off the ground. If the dish always must be opened when the correct animal wants to eat, the movement and noise of the dish would scare the correct animal away. This is very disadvantageous because it inhibits a pet from eating in a relaxed atmosphere and can cause a pet to develop an eating disorder.

With the present invention, the sound of the motor and opening of the dish and other cues that occur will only scare the animal who is the wrong or unwanted animal. Use of such cues to train the unwanted animal overcomes the disadvantages of prior art devices and enforces a useful behavioral change in the animal to not eat out of the wrong food dish. It is desirable to provide a system where the correct animal that should be eating out of the dish never has to see the dish move or hear any motor noise or receive any other negative cues, which scare the animal.

Further, there is desired a system that will prevent access to a litter box by an unwanted pet. It is common for dogs to access a cat's litter box in order to eat its feces. This problem can make the dog ill and requires expensive visits to the veterinarian in order to cure the dog. Thus, there is desired a simple and inexpensive system which will prevent the unwanted pet from accessing a device, such as a litter box.

### SUMMARY OF INVENTION

The present invention provides a system for preventing access to a device by an unwanted animal, the device includes a housing having a cover, a storage area, a motor, a sensor and a transmitter placed on the unwanted animal and the sensor responding to the transmitter when it is in close proximity to the device to activate the motor in order to actuate the cover to prevent access by the unwanted animal.

In an embodiment, the device may be a pet dish for holding pet food and the cover completely encloses an opening of the dish so that an animal cannot eat food in the storage area of the dish. In an embodiment, the device may be a litter box for containing pet feces in the storage area and the cover includes a door that covers an opening of the box. In an embodiment, the door may include a lock that is actuated by the motor in order to lock the door to prevent access by the unwanted animal. In an embodiment, the motor may actuate the cover so that it moves from an open condition to a closed condition.

In an embodiment, the cover may be actuated between an open and a closed condition. In an embodiment, the cover may include a first half and a second half and each half is pivotally mounted on the housing, so that when the first half abuts the second half the device is completely covered and in the closed condition. In an embodiment, each half may be semi-spherical. In an embodiment, each half is hinged at a midline and in the closed position each half extends from the midline from the side of the housing. In an embodiment, each half may be hinged at an edge in the closed position the edge is adjacent a side of the housing.

In an embodiment, the cover may include a first half and a second half and each half is able to slide to a closed position where each half is abutting the other half and encloses the housing. In an embodiment, the cover may include a first half and a second half and each half includes articulated sections that are deformed in an open position. In an embodiment, the cover may include a first and second half each having a dome shape.

In an embodiment, the cover may form an iris-like interleaved lid that is supported at an opening of the housing. In an embodiment, the motor may actuate the device between an open and closed condition. In an embodiment, the device may be mounted to a motorized track that moves the device to the closed condition under the cover and the open condition disposed away from the cover. In an embodiment, the cover may be disc shaped and includes a pivot point upon which this disc rotates between the open and closed condition. In an embodiment, the cover may be formed of a pair of semicircular shaped discs which each include a pivot point located on opposite sides of the device and upon rotation of the halves on each of the pivot points, the halves abut each other and enclose the device. In an embodiment, the lid may be a pivotally attached disc which pivots between the opened and closed position.

In an embodiment, the device may include a column having a plate mounted therein and the plate is actuated between a lower and upper position accessible to the animal. In an embodiment, the device may be mounted on a platform that raises and lowers the device in order to come in contact with the cover in order to close the device. In an embodiment, the device may be a cylinder with an open hole and the cylinder rotates in order to align the hole with the device to provide access to the animal. In an embodiment, the cover may include two halves that slide on top of one another and overlap horizontally in order to close the device. In an embodiment, a threaded shaft may be provided along the longitudinal axis of the device and has the cover mounted thereon and inserted through a threaded hole of the cover so that upon rotation of the shaft the cover will ride along the threaded shaft between the open and closed condition.

In an embodiment, the device may be a box having a horizontally sliding front door which exposes the device mounted therein. In an embodiment, the cover may be a flat accordion door that folds between the open and closed condition. In an embodiment, the device may include a cylinder that surrounds the device and the cylinder is moveable between a lowered and elevated position in which to conceal the device and prevent access by the animal. In an embodiment, the lid may be suspended by a wire and the actuation of the motor causes the wire to lower the lid to the closed condition. In an embodiment, the cover may be formed of a flexible material which is wound in a roll adjacent an opening at the top of the device and may be unrolled to cover the opening in order to provide the cover in the closed condition. In an embodiment, the cover may be formed of slats which slide to block the opening of the device.

In an embodiment, the cover may form a V shape extended above the top of the device in the open condition and collapses flat in order to cover the opening and provide the cover in the closed condition. In an embodiment, the device may be provided within a box having a first end and a second end and a hole formed in the first end and the device is moveable between the first end and the second end and at the first end the device is adjacent the hole in the box so that access is provided to an animal and provides the cover in the open condition.

In an embodiment, the device may include a netting for receiving food therein and upon actuation of the motor the netting is raised out of the device to provide access to the animal in the open condition.

In an embodiment, the device may include a cylinder mounted within an outer cylinder having a hole therein and the device may rotate within the outer cylinder in order to align the opening of the device with the opening of the outer cylinder in the open condition. In an embodiment, the cover may include two halves hinged at a middle area of the device and in the open condition the halves extend upward at the center in order to bisect the device. In an embodiment, the cover may include a single dome that rotates over the device in order to provide the closed condition. In an embodiment, three segments may provide for the cover and slide between the open and closed condition. In an embodiment, the cover may be oriented at the top of the device at a skewed angle and the cover slides upwardly to enclose the top of the device. In an embodiment, the cover may include a single hinged door that has a generally vertical orientation in a closed position and a generally horizontal orientation in the open condition. In an embodiment, the motor may actuate a latch placed adjacent the door in order to lock the door in the closed condition.

In an embodiment, the motor may actuate the door to move between the opened and closed condition. In an embodiment, the unwanted animal may be a dog. In an embodiment, the unwanted animal may be cat. In an embodiment, the unwanted animal may be livestock. In an embodiment, the wanted animal may be a cat and the device remains in the open condition in order to treat bulimia of the cat.

In an embodiment, the sensor may include a receiver for receiving a signal from the transmitter and a circuit for activating the motor in order to activate the cover. In an embodiment, the device may include a timer for deactivating the actuator and allowing the device to be opened and accessed by the wanted animal. In an embodiment, the device may be a subcomponent of a larger device and may be attached to the larger device in order to prevent access to the larger device. In an embodiment, the device may be a door assembly that may be attached to a litter box in order to modify the litter box so that it can prevent access by an unwanted animal. In an embodiment, the device may be a cover assembly that may be attached to feeding dish in order to modify the feeding dish so that it can prevent access by an unwanted animal.

In a further embodiment, the present invention provides a method of altering an animal's behavior comprising the steps of providing a device with a cover that has an open and closed condition, a sensor that activates the cover and a transmitter for a first animal, providing the device in the open condition where the cover does not block access and allows a second animal to access the device, activating the sensor upon receipt of a signal from the first animal's transmitter when the first animal is in close proximity to the sensor, actuating the cover to the closed condition by the sensor when the first animal is in the close proximity, providing a cue for the first animal, the cue occurring due to the actuation of the cover from the open condition to the closed condition in order to prevent access to the first animal, causing the first animal to move away from the device due to the cue and actuating the cover to the open condition by activation of the sensor when the first animal's transmitter exits the close proximity. In an embodiment, the cue may be a visual cue caused by the closing of the cover. In an embodiment, the cue may be an audible stimulus caused by the closing of the cover. In an embodiment, the cue may be an audible stimulus caused by a motor of the device activated by the sensor to close the cover. In an embodiment, the device may be a pet dish for holding pet food. In an embodiment, the device may be a litter box for holding pet feces.

In an embodiment, the method may further comprise the step of allowing the second animal to have free access to the device that will remain in the open condition, so long as the first animal is not in the close proximity. In an embodiment, the method may further comprise the steps of providing a transmitter for the second animal and activating the sensor upon receipt of a signal from the second animal's transmitter in order to maintain the cover in the open condition, when the first animal is in close proximity. In an embodiment, the cover may include: a first half and a second half that each rotate toward each other and providing a clam shell like assembly and upon abutment of the first half against the second half so that the cover is in the closed condition.

In an embodiment, the cover may include a door having a lock and the method further comprising the steps of activating the lock by triggering of the sensor by the transmitter being in the close proximity and locking the door so that the device may not be accessed by the first animal. In an embodiment, the cue may be a negative reinforcement based stimulus that trains the first animal to keep away from the device. In an embodiment, repeated attempts by the first animal to access the device acts to modify the behavior of the first animal in order to cease its attempts to access the device despite the actuation of the cover.

In another embodiment, the invention provides a method for deterring an animal from accessing a device comprising the steps of providing a device having a receiver and a cover, attaching a transmitter to an animal, generating a signal from the transmitter to the receiver and actuating the cover in response to the receiver being triggered by the transmitter signal. In an embodiment, the actuation of the cover may further comprise the step of locking the cover in a closed condition. In an embodiment, the actuation of the cover may further comprise the step of moving the cover from an open to a closed condition.

In a further embodiment, the invention provides a method for treating a bulimic animal comprising the steps of providing a food dish having a cover and a sensor, the dish for holding food for a first animal that is bulimic, placing a transmitter on a second animal, triggering the sensor to actuate the cover to move to a closed condition only when the second animal's transmitter is signaling the sensor and maintaining the cover in an open condition so that the bulimic animal's food is visible when the second animal is not present.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic view of a system of the present invention with a device in the open condition;

FIG. 2 is a schematic view of another embodiment of a system of the present invention with a device in an open condition;

FIG. 3 is a schematic view of the embodiment of the system of FIG. 1 depicted in the activated or closed condition;

FIG. 4 is an exploded view of the device of FIG. 1;

FIG. 5 is an exploded view of a transmitter of FIG. 1;

FIG. 6a is a block diagram of the functional characteristics of a transmitter of the present invention;

FIG. 6b is a block diagram of the functional characteristics of a device of the present invention;

FIG. 7a is a side elevation view of an alternate embodiment of a device of the present invention in the open condition;

FIG. 7b is a side elevation view of the device of FIG. 7a in the closed condition;

FIG. 8a is a side elevation view of an alternate embodiment of a device of the present invention in the open condition;

FIG. 8b is a side elevation view of the device of FIG. 8a in the closed condition;

FIG. 9a is a side elevation view of an alternate embodiment of a device of the present invention in the open condition;

FIG. 9b is a side elevation view of the device of FIG. 9a in the closed condition;

FIG. 10a is a side elevation view of an alternate embodiment of a device of the present invention in an open condition;

FIG. 10b is a side elevation view of the device of FIG. 10a in the closed condition;

FIG. 11a is a perspective view of an alternate embodiment of a device of the present invention in an open condition;

FIG. 11b is a perspective view of the device of FIG. 11a in the closed condition;

FIG. 12a is a perspective view of an alternate embodiment of a device of the present invention in an open condition;

FIG. 12b is a perspective view of the device of FIG. 12a in a closed condition;

FIG. 13a is a perspective view of an alternate embodiment of a device of the present invention;

FIG. 13b is a sectional view taken at line 13b-13b of FIG. 13a;

FIG. 13c is a sectional view taken at line 13c-13c of FIG. 13b;

FIG. 13d is a view similar to FIG. 13c in the open condition;

FIG. 14a is a side elevation view of an alternate embodiment of a device of the present invention;

FIG. 14b is an enlarged section view of a latch of FIG. 14a;

FIG. 14c is an enlarged section view of a latch in an unlatched condition of FIG. 14a;

FIG. 15a is an alternate embodiment of the device of the present invention in an open condition; and

FIG. 15b is a side elevation view of the embodiment of FIG. 15a in a closed condition.

### DETAILED DESCRIPTION

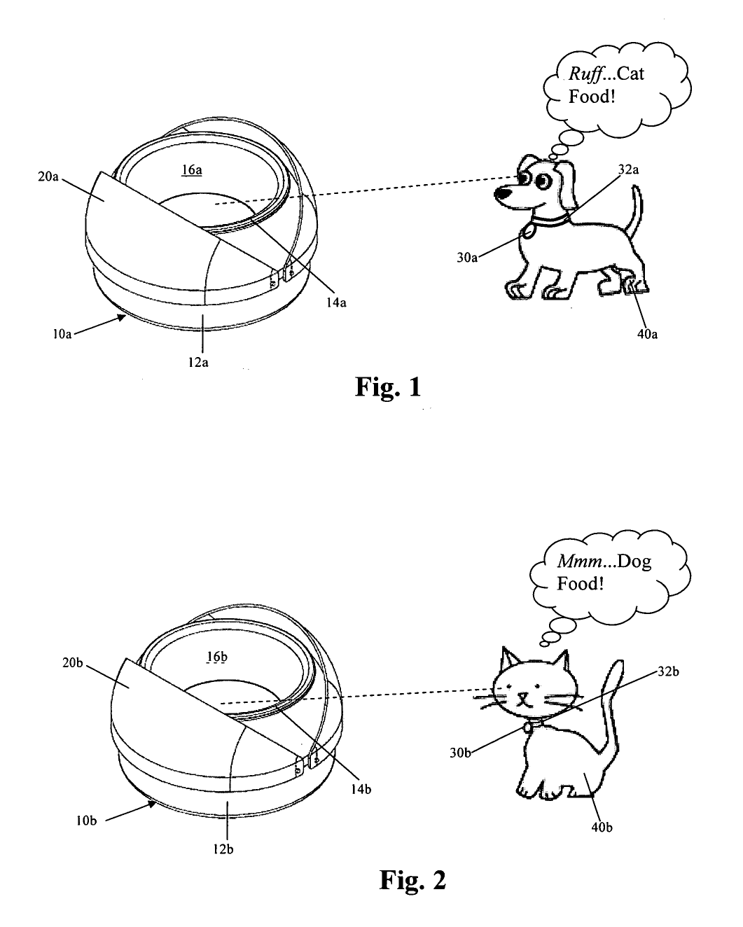

An embodiment of a system of the present invention is depicted with respect to FIGS. 1-15b. FIGS. 1-3 are a schematic representation of an implementation of the invention and although it depicts a specific device, alternate embodiments of the device are anticipated and will be discussed in more detail in following paragraphs. In general the system includes a device 10a, 10b, for example a feeding dish for an animal such as a dog, cat or livestock. As shown in FIGS. 1 and 2 the device 10a, 10b is in an open, non-activated condition. The device in general includes a housing 12a,b forming an opening 14a,b, a storage area 16a,b and a cover 20a,b. The system also includes a transmitter 30a,b. In an embodiment, the transmitter 30a,b is worn on a collar 32a,b of the unwanted pet or animal 40a,b.

FIG. 1 depicts a dog 40a that is the unwanted animal that should not be eating from the device or bowl 10a. In a normal setting in a home that has multiple pets that have different diets, multiple bowls or devices such as 10a, 10b will be located within the house. For example, the bowl 10a may be the eating dish for a cat. It is well-known that cat food is richer and higher in fat than dog food and is therefore usually more desirable for a dog than its own prescribed food. As the dog 40a should not be eating from the bowl 10a having cat food, the dog 40a in the example depicted in FIG. 1 is the unwanted animal.

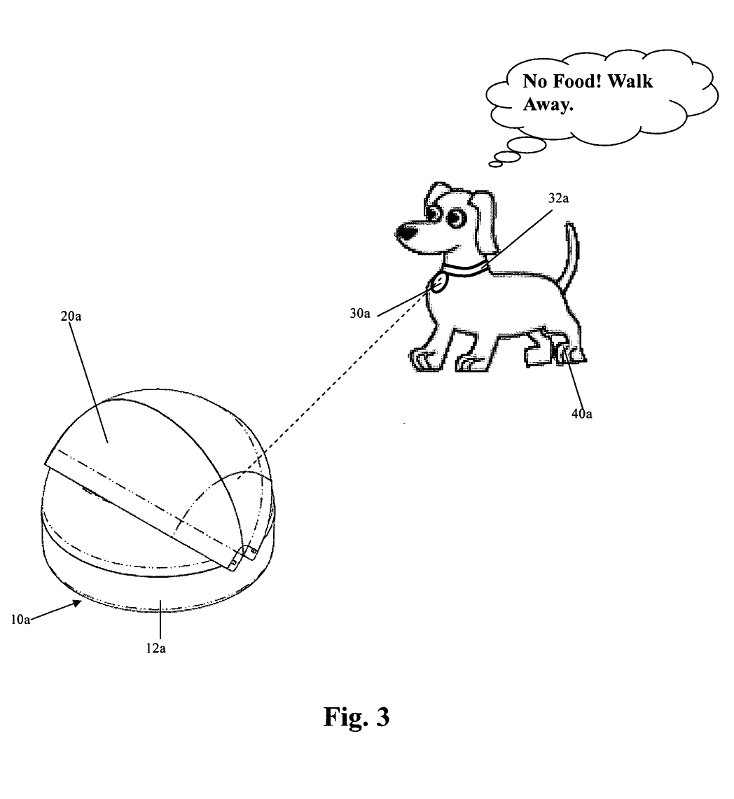

The bowl 10a includes a sensor that can receive signals from the dog's transmitter 30a so that when the dog 40a is within close proximity to the bowl 10a, for example within 1 to 10 feet, the bowl 10a will be activated and will cause the cover 20a to move from its open condition, as shown in FIG. 1, to its closed condition, as shown in FIG. 3. Therefore, as shown in FIG. 3 the dog, or unwanted animal 40a will not be able to access the storage area 16, as it will be enclosed by the cover 20. The device 10a includes a motor which activates the cover 20a and moves it from the open to the closed condition.

It is a further feature of the present invention that the device 10a provide cues to the unwanted animal to indicate that it should not be feeding from the device. The cues provided to the animal may include indicia for the animals sight, sound or smell. For example, the activation of the cover 20a to the closed condition as shown in FIG. 3 provides for a visual cue that the bowl is closed and the animal cannot access the food within the storage area 16. As well, the sound of the motor actuating the cover 20a may be an audible cue to the animal that the device is going to be activated and moved to a closed condition. Some animals are very frightened of noises and the sound of the motor alone will cause the animal 40a to become frightened and move away from the bowl 10a. As well, the device 10a may provide for a “clicking” or “slamming” sound when the cover 20a is moved to the closed condition. For example, as shown in FIGS. 1 and 2 the cover has two halves which abut each other in the closed condition, as shown in FIG. 3. The movement of the two halves together may provide for the “clicking” or “slamming” sound, which will be an audible cue to the unwanted animal 40a that it cannot have access to this feeding dish 10a. Further, other types of cues may be provided by the device 10a such as the illumination of lights, triggering of a speaker which transmits an alarm, sound or a pre-recorded voice. The device may also transmit a smell via a pump mechanism disbursing a chemical into the air.

Turning to FIG. 2, it is to be understood that the cat depicted may be the unwanted animal 40b with respect to the bowl 10b. The device works as described above in order to prevent the cat 40b from accessing the storage area 16 of the bowl 10b. As the cat gets in a close proximity to the device 10b, its transmitter 30b will activate a sensor of the device 10b and cause the cover 20b to move from its open condition as shown in FIG. 2 to a closed condition similar to that shown in FIG. 3.

It is to be understood with respect to FIGS. 1 and 2 that multiple bowls 10a, 10b may be present in the same home and the bowl 10a may be the feeding dish for the cat 40b and the bowl 10b may be the designated feeding dish for the dog 40a. Thus, the dog 40a may be the wanted animal with respect to the bowl 10b and the cat may be the wanted animal 40b with respect to the bowl 10a. However, it is to be understood that the dog is the unwanted animal 40a with respect to the bowl 10a and the cat is the unwanted animal 40b with respect to the bowl 10b. It is to be understood, of course, that the unwanted animal for the bowl 10b may be another dog or another cat depending on the type of food that is provided for by the bowl 10b. It is also to be understood that the present invention is not limited to a bowl for a domestic pet and may be used for livestock and a wide variety of devices, such as discussed below, can act as the feeding mechanism.

Also, as will be discussed below the device 10 need not be a feeding mechanism, but might be another area where an animal should be denied access, such as a litter box or other device. It is to be understood that the system of providing cues to the animal will act to modify the behavior of the unwanted animal. After repeated attempts to access the device 10 and repeated sensing of the cues (e.g. lights, sounds, smell, closed cover, etc.) by the unwanted animal 40a, the unwanted animal will change its behavior and will cease attempting to access the device (despite the fact that the cover is open). For example, the cue may be a recording of the unwanted pet owner/caretaker's voice saying “NO!” This type of cue, provided at the same time that the cover 20 is activated can act to reinforce the negative input to the unwanted animal 40a and more effectively modify the unwanted animal's behavior.

Furthermore, if the cue is duplicative of a previously provided cue, the method of altering behavior of an animal by the present invention may be more pronounced. In an embodiment, the previously provided cue is the animal caretaker's voice command that directs the animal's behavior. The duplicative cue is a recording of the animal caretaker's voice command. For example, if the caretaker's usual command to the unwanted animal is to say “NO” in other circumstances when the unwanted animal 40a is misbehaving; the repetitive use of the same cue (recording saying “NO”) by the device 10 will more strongly enhance the behavior modifying effect of the device 10. In fact, the automatic and repetitive cue provided by the device 10 every time the unwanted animal 40a attempts access, will help to reinforce the caretaker's use of the vocal cue (even if not provided to the animal every time) when attempting to alter the unwanted animal's behavior in other situations. The effectiveness of negative behavior modification is well known and other means of implementing the present invention in order to modify an unwanted animal's behavior are also contemplated. For example, the device 10 may activate a vibrator or other electronic stimulus on the collar 32 of the unwanted animal 40a at the same time that the cover 20 is activated and other cues are provided.

The device 10 of the present invention, with respect to the food bowl 10a,b, also has a positive behavior modification aspect as well. The ability of the device to remain in the open condition most of the time (except when the unwanted animal is present), allows the wanted animal to be able to see the food in the storage area 16 of the bowl 10 which has a reassuring affect. Many animals will beg for food when the food bowl is nearly empty—not because the animal is hungry, but to reassure the animal that it's supply of food is plentiful and it will not starve. In cases where a caretaker is worried that the unwanted animal 40a may eat the food, it is common to allow the food dish to become empty after the wanted animal has eaten, so that the unwanted animal cannot eat afterward. Use of the present invention allows the bowl 16 to be completely filled with food all the time, because the unwanted animal cannot access the food. The ability of the wanted animal to see the full bowl will reduce begging and make for a much happier pet. This constant positive visual cue of the device 10 in the open condition is especially helpful for animals with eating disorders, such as bulimia.

Turning to FIG. 4 the particular components of an embodiment of the bowl 10a will be described in more detail. As discussed above, the device 10 includes a housing 12 providing a storage area 16 having an opening 14. A bowl 17 is provided that is designed to fit within the storage area 16. In a preferred embodiment, the bowl 17 is removable so that food may be placed in the bowl and then the bowl 17 placed within the opening 14 of the device 10. The device 10 includes a cover 20. In the embodiment depicted in FIG. 4, the cover includes a first half 21 and a second half 22. Each half 21, 22 is pivotally mounted on the housing 12. An aperture 18a,b is provided on the housing 12 for receiving a pin inserted into apertures 19a,b provided on each half 21, 22 which is inserted through the apertures 18a,b in order to pivotally attach the halves 21, 22 to the housing 12. As depicted in FIG. 4 the halves may be semi-spherically shaped and may pivot on the housing between an open condition, as shown in FIGS. 1 and 2 and a closed condition, as depicted in FIG. 3. As will be discussed in greater detail below, the cover 20 may have many different orientations and shapes and mechanisms for obtaining an open or closed condition.

The device 10 includes a base 24. Disposed within the base 24 is a sensor assembly 25 which includes a printed circuit board 27, receivers 28a,b,c,d and an integrated circuit 30. In an embodiment, the integrated circuit 30 is a microprocessor which helps to control the receivers and actuates the motor, as will be described in greater detail below. The motor 33 has a worm gear 35 for engaging a first shaft 34 which has a pair of gears 35, 36. The first gear 36 engages a second gear 37 of a second shaft 38. The first shaft 34 causes the first half 21 to pivot and move between the open and closed condition and the second shaft 38 causes the second half 22 to be actuated between its open and closed condition. The first shaft 34 has an end which is inserted through aperture 18b and 19b in order to actuate the first half 21. The second shaft 38 has its end extending through aperture 18b at 19a in order to actuate the second half 22. The base also includes a power source, such as batteries 41. The base 24 also includes a window 42 that is aligned with the receiver 28a. In an embodiment four receivers 28a,b,c,d are provided and each receiver will have a corresponding window 42 oriented around the perimeter of the base 24. It is to be understood, however, that more or less receivers may be provided and each having a corresponding window. The base 24 may also include pads 44 which may be placed on the bottom of the base 24 in order to help support the base on a surface such as a floor.

The assembly of the device 10 occurs by mounting the circuit board 27 within the base so that the receivers 28a,b,c,d are aligned with the windows 42. The gear shafts 34, 38 are then aligned with the apertures 18a,b and 19a,b and the housing 12 and lid halves 21, 22 mounted thereon. The bowl 17 may then be placed in the opening 14 and batteries 41 provided in the holder for the power source 40.

It is to be understood that the receivers 28a,b,c,d are able to receive signals from the transmitter from the unwanted animal 40a,b. In an embodiment, the receiver may be an IR (IR) detector. The preferred embodiment disclosed in FIG. 4 provides for four detectors 28a,b,c,d which are oriented equidistantly around the sides of the base 24. In alternate embodiments, more or less receivers 28 may be provided depending on the strength of the transmitter 30 being worn by the unwanted animal and the desired proximity at which the sensor assembly is to be triggered.

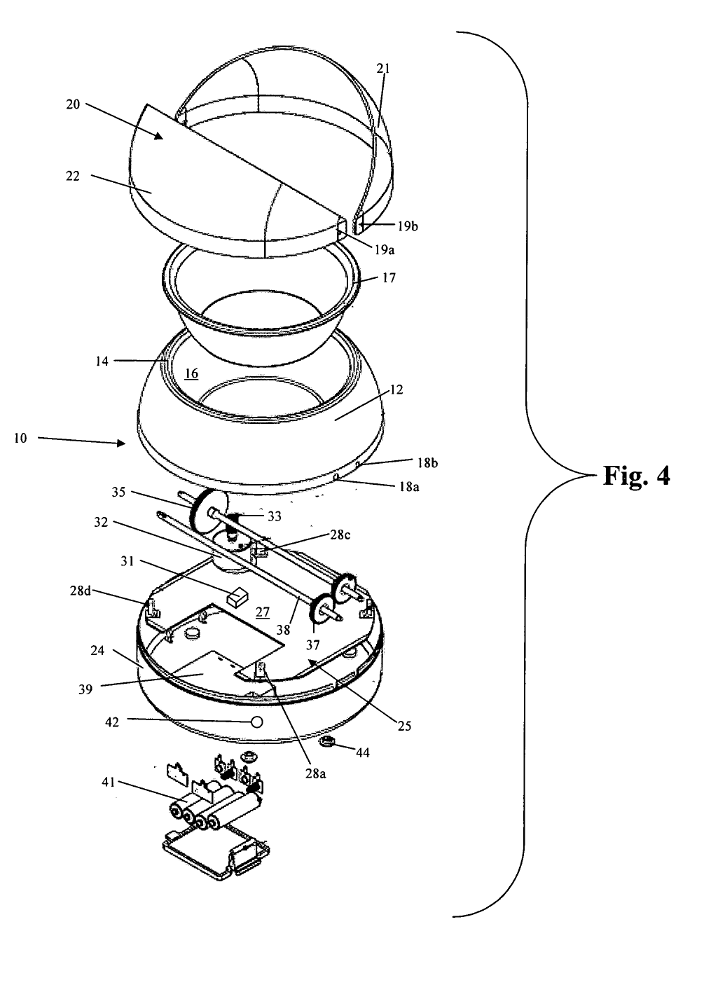

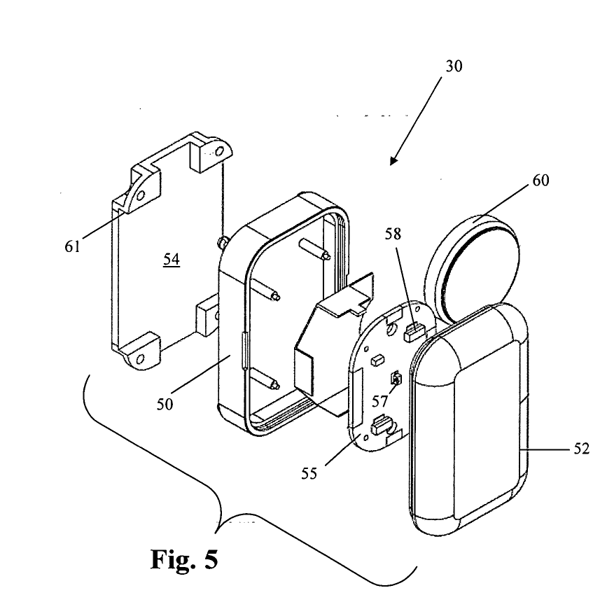

Turning to FIG. 5 an embodiment of the transmitter 30 of the present invention is depicted. The transmitter 30 includes a housing 50 having a top 52 and a bottom 54. A printed circuit board 55 is mounted within the housing 50 and includes a transmission circuit 57 and an integrated circuit 58. In an embodiment, the transmission circuit 57 is an IR LED. In an embodiment the integrated circuit is a microcontroller. A power source 60 is mounted within the housing 50. In an embodiment, the power source 60 may be a lithium battery.

The bottom 54 includes a channel 61 for receiving an animal's collar therethrough. Thus in the preferred embodiment the transmitter 30 has a width that is a bit wider than the width of a standard animal collar (e.g., a half to one inch). Once the transmitter 30 is assembled by mounting the printed circuit board 50 and the battery 60 within the housing 50 and attaching the top 52 and bottom 54 to the housing 50, the transmitter may be fastened to the collar of an animal. In alternate embodiments, the transmitter 30 may take other forms such as smaller packages such as a tag 30a and 30b as shown in FIGS. 1 and 2. In further alternate embodiments, the transmitter may be miniaturized to the extent that it may be inserted under the skin of an animal.

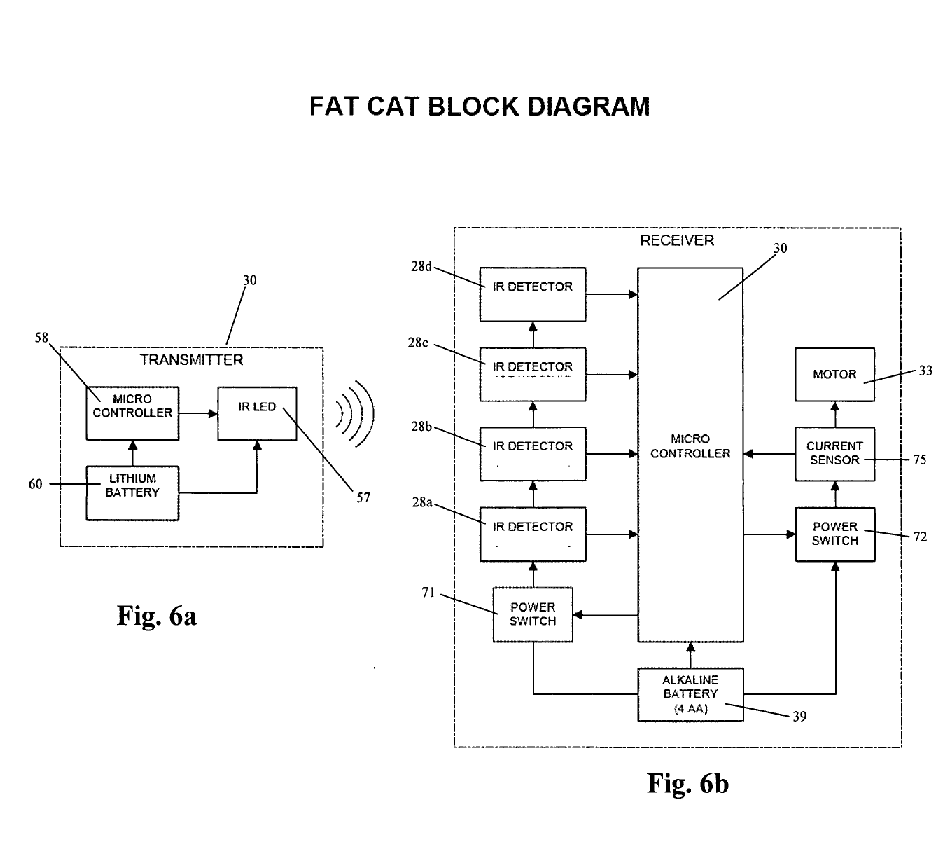

Turning to FIG. 6a, the block diagram for an embodiment of the present invention is depicted. The transmitter 30 includes a battery 60 which provides power to the microcontroller 58 and the IR LED 57. The microcontroller 58 sends signals to the led in order to trigger the transmission of the LED. In an embodiment, the microcontroller 58 will be programmed in order to trigger the LED to transmit once every half second. In an embodiment, the battery is a lithium battery manufactured by CR and is model number 1632. In an embodiment, the microcontroller is model number PIC 10F200 manufactured by Microchip Technology, Inc., Chandler, Ariz., USA 85224. In an embodiment the IR LED is manufactured by OSRAM, Hellabrunner Strasse 1, 81543 München, Germany and is model number SFH 4010. In an embodiment, the battery for transmitter is model no. CR1632 manufactured by Energizer, St. Louis, Mo. USA 63141. However as is well-known in the art many alternate types of batteries, integrated circuits and transmitters may be used.

FIG. 6b is the block diagram for the device 10 which includes the power source 39 which is attached to a first power switch 71 and a second power switch 72. The first power switch provides power to the detectors 28a,b,c,d. The second power switch 72 controls the power to a current sensor 75 which controls the motor 33. In an embodiment, the motor 33 is manufactured by Ningbo DSW Electronics Co., Ltd., Ningbo City, 315000, China and is part no. RF-300CH. The power source 39 also provides power to the microcontroller 31. When the transmitter 30 is in the vicinity of the device 10 the IR LED transmits a signal that will be received by at least one of the detectors 28a,b,c,d and the detector will then transmit a signal to the microcontroller 31. The microcontroller will then trigger the power switch 72, which will activate the current sensor 75 that will activate the motor 33. As discussed above, the motor 33 will then rotate the worm gear which will actuate the cover 20, in order to move the cover 20 from the open to the closed condition. In an embodiment, the power switches 71, 72 are manufactured by Dragon City Industries, Ltd., Shatin, N.T., Hong Kong SAR. In an embodiment, the current sensor 75 is manufactured by Panasonic, Secaucus, N.J. USA 01094.

The microcontroller 31 includes a timing device and can be programmed to measure the interval of time elapsed from when the power switch is triggered. In an embodiment, the microcontroller 31 may provide for an elapsed time of two minutes from the time the power switch is activated and the lid is moved to the closed condition. After two minutes the microcontroller will activate the power switch a second time, which will trigger the current sensor in order to activate the motor in order to move the worm gear in the opposite direction in order to move the cover 20 to the open condition. The microcontroller 31 can also be programmed to sense whether, during the elapsed time, additional signals have been transmitted from one of the detectors 28a,b,c,d which would indicate that the unwanted animal is still present in the vicinity of the device 10. In an embodiment, the microcontroller 31 may be programmed so that the elapsed time does not begin until it has stopped receiving signals from each of the detectors 28a,b,c,d.

Other functionality may be provided by the device 10 and may be programmed into the microcontroller 31. For example, the device 10 may include an alarm such as a speaker which will emit an audible sound. In an embodiment, the circuitry may include a recording device in order to record the voice of the unwanted animal's owner, so that upon triggering of the sensor it activates the motor and also the speaker in order to emit the recorded voice. Other functionality may be provided by the circuitry such as transmitting a signal to another sensor in a remote site, such as the bedroom of the unwanted animal's owner.

In an embodiment, the IR detectors 28 are manufactured by Sharp Microelectronics, Camas, Wash. USA 98607-9489 and are model number GP1UD28YK and the microcontroller is manufactured by Microchip Technology Inc. Chandler, Ariz., USA 85224 model number PIC 16F676.

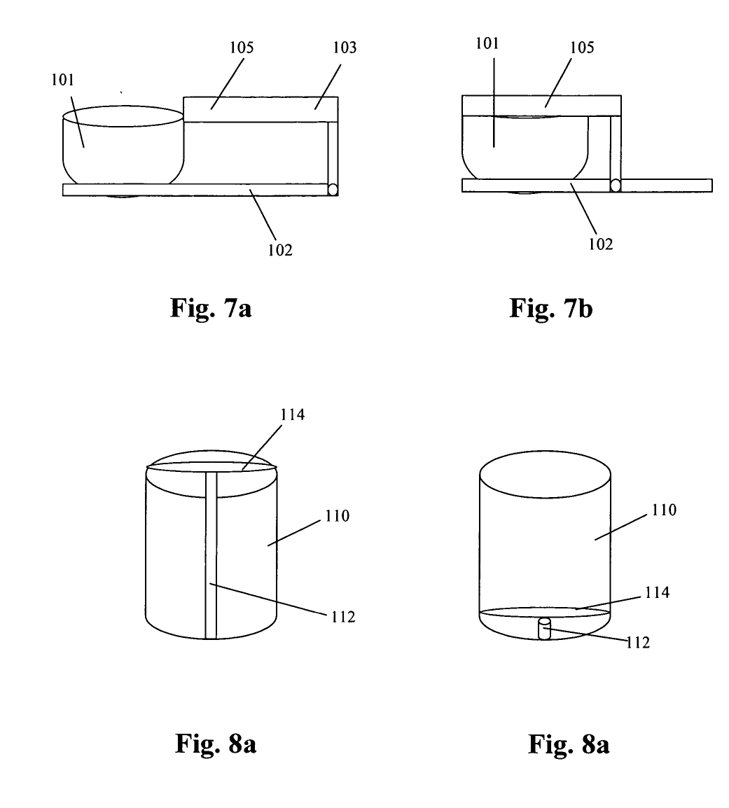

FIGS. 7-13d depict alternate embodiments of the device of the present invention. FIG. 7a depicts a device having a bowl 101 which is mounted on a track 102 and upon activation of a motor the track causes the bowl to move within the housing 103 so that the cover 105 encloses the top of the bowl 101, as shown in FIG. 7b. Therefore it may be understood that the wanted animal may be able to eat from the bowl when it is in the open condition 101, but when the unwanted animal is present the bowl 101 is moved to the closed condition, as shown in FIG. 7b, so that the cover 105 is enclosing the top of the bowl 101 and the unwanted animal cannot access the food.

FIG. 8 depicts a cylinder 110 having a shaft 112 mounted on the longitudinal axis and a plate 114 mounted on the shaft and upon activation of the mechanism, due to the proximity of the unwanted animal, the shaft 112 retracts the plate 114 as shown in FIG. 8b, so that a bowl mounted on the plate 114 is retracted within the cylinder 110 and cannot be accessed by the unwanted animal. The shaft may be a threaded shaft which is received in a threaded hole of the plate 114 so that rotation of the shaft causes the plate 114 to wind downward along the shaft 112 to the closed condition.

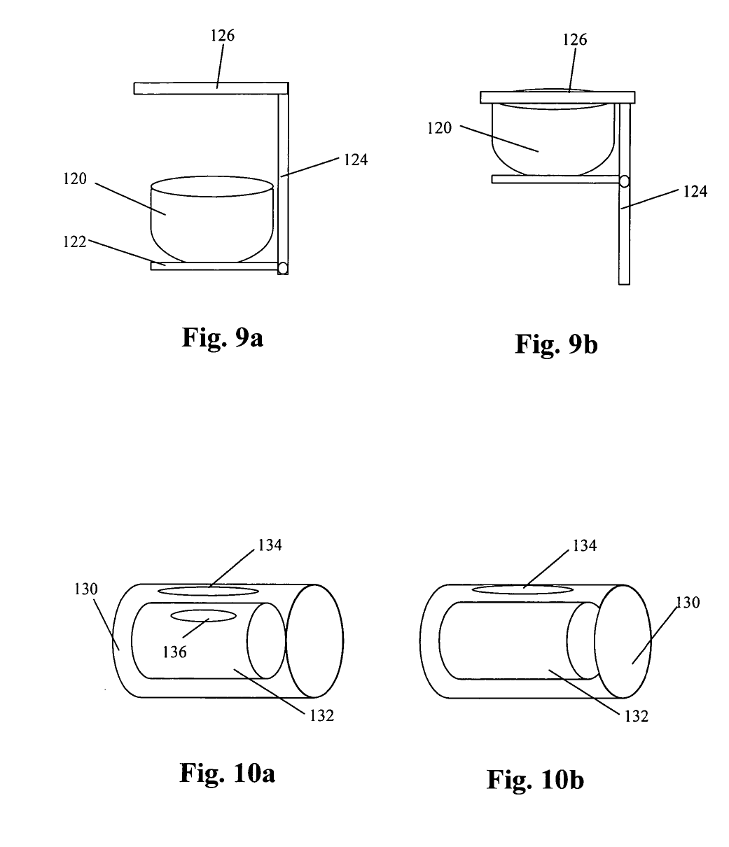

FIG. 9 depicts a bowl 120 mounted on a platform 122 and upon activation of the sensor, due to the proximity of the unwanted animal, the platform 122 is elevated along a wall 124 as shown in FIG. 9 in order to move the bowl 120 upward until the top is abutting a cover 126, so that it encloses the top opening of the bowl 120. Therefore, it may be understood that in the open condition shown in FIG. 9, a wanted animal can access the food from the bowl 120. However, in the activated and closed condition, shown in FIG. 9b, the cover 126 encloses the top of the bowl and cannot be accessed by the unwanted animal.

FIG. 10 discloses an outer cylinder 130 having an inner cylinder 132. The outer cylinder includes an opening 134 and the inner cylinder includes an opening 136. Upon activation of the sensor by the unwanted animal, the inner cylinder 132 is rotated as shown in FIG. 10b, so that the openings 133, 136 are not in alignment and therefore access to the food is prevented. Thus, it is to be understood that when the unwanted animal is not present the cylinder 132 has its opening 136 aligned with opening 134, so that the contents of the cylinder 132 may be accessed by the wanted animal. However, as shown in FIG. 10b the cylinder 132 is in the closed condition denying access to the unwanted animal.

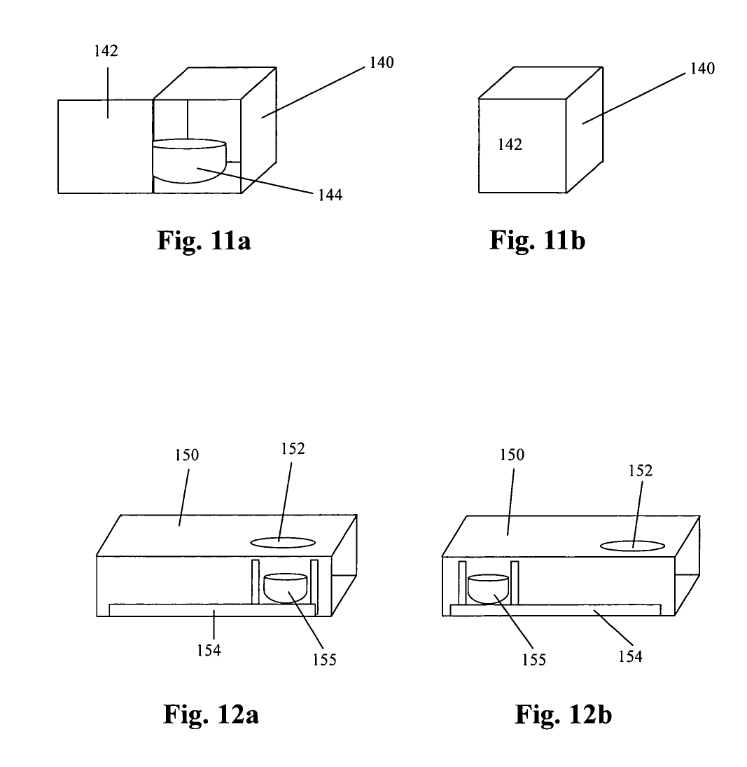

FIG. 11 depicts a housing 140 having a cover 142 and a bowl 144 disposed within the housing 40. In the open condition the cover 142 is slid so that the bowl 144 may be accessed within the housing 144. In the closed condition, as shown in FIG. 11b, the cover 142 is slid or pivoted to its closed position so that the bowl cannot be accessed by an unwanted animal. Any known way of moving the cover 142 over the opening of the housing 142 may be provided such as via hinges, pivots, fasteners or flexible members.

FIG. 12a depicts a housing 150 having an opening 152 and disposed within the housing is a track 154 and a bowl 155 mounted on the track. In the open condition the bowl is positioned on the track at the first end of the housing adjacent the opening 152, as shown in FIG. 12b. FIG. 12a depicts the device in the closed condition, where the track 154 actuates the bowl 155 in order to move it to the second end of the housing, so that it is not adjacent to the opening 152 and an unwanted animal cannot access the bowl 155.

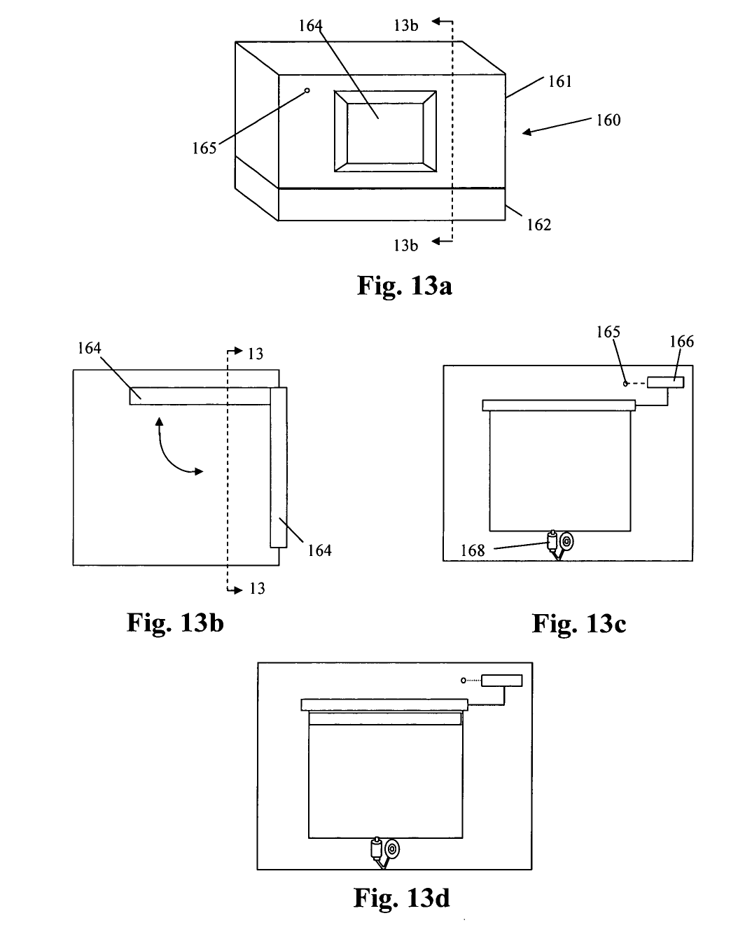

FIGS. 13a-13d depict a further embodiment of the present invention wherein the device 160 is a litter box. The litter box includes an enclosed housing 161 and a base 162. The base includes sides to hold kitty litter where the cat will defecate. The housing includes a cover 164 such as a hinged door. The housing includes a sensor 165 adjacent the door. FIG. 13b shows a door in the closed condition 164a and the open condition 164b. A motor 166 is depicted in FIG. 13c that activates the door between the open and closed conditions 164a,b. A latching mechanism 168 is provided at the base of the door 164. In the closed condition the latch 168 is activated so that it locks the door 164 in the closed condition as shown in FIG. 13c. This is the condition that the device 160 will be in when an unwanted animal is in the vicinity of the device. For example, a dog who may want to eat cat feces from the box 160 will be prevented from entering the housing 161 because the transmitter on the unwanted dog's collar will activate the sensor 165 and actuate the lock 168 in order to latch the door in the locked condition, so that when the dog tries to push its head through the door 164, the door 164 will not move.

However, after the unwanted animal leaves the vicinity, the motor will activate the latch 168 so that it unlocks and the door may be moved to the open condition as shown in FIG. 13d. In an embodiment, the latch may merely move to an unlocked condition, so that when the rightful user of the litter box approaches, the cat may push its head easily through the door. However, in an alternate embodiment, the exiting of the dog from the area may activate a motor which will move the door to the open condition.

In a further embodiment, the housing 160 may include a light or audible alarm which indicates when the latch 168 has been activated. In this way, a dog or unwanted animal may be trained to be aware when the device is in the locked condition so that the dog need not even try to push its head through the door 164 and will know beforehand that based on the visual or audio signal or cue that the device has been activated and the unwanted animal's unwanted activity cannot occur.

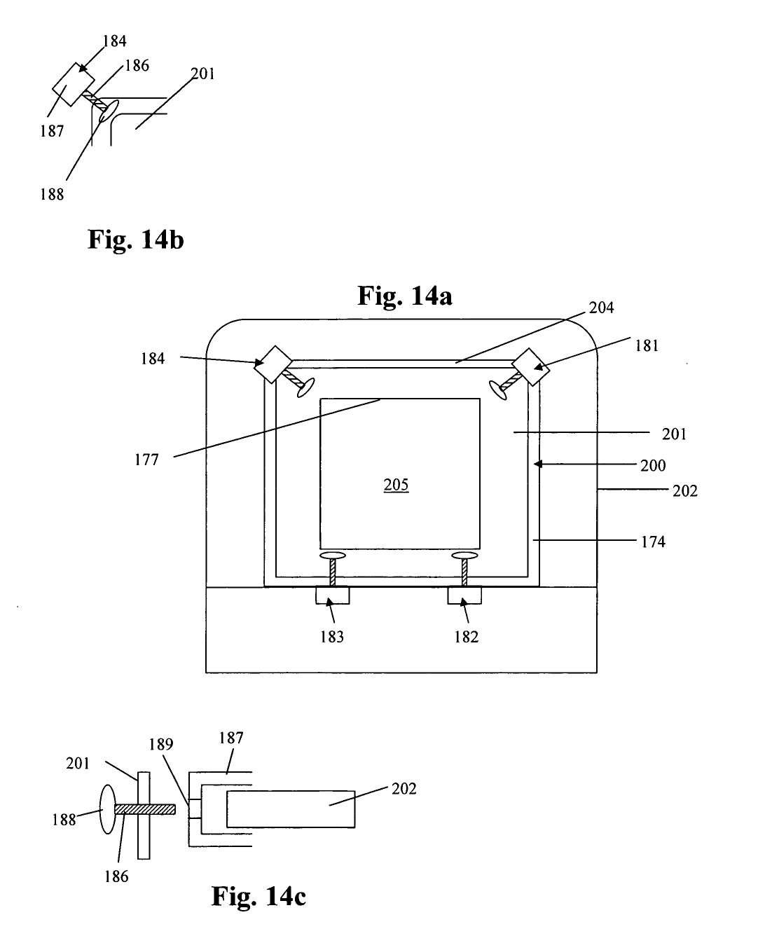

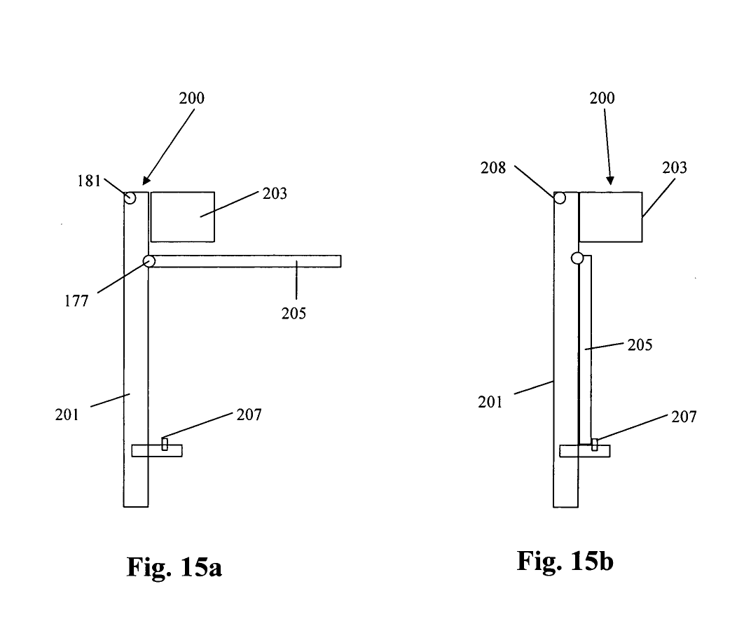

FIG. 14a-15b are a further alternate embodiment of the present invention which provides for a modular door assembly 200. The door assembly includes a housing 201 which forms a frame and a sensor assembly 203, a door 205 and a latch 207. This door assembly 200 operates similar to the device discussed above in that the sensor assembly 203 includes a sensor such as an IR detector which actuates the latch 207 so that the door 205 may be moved between its open and closed condition. When the sensor detects an unwanted animal via its transmitter, the sensor will activate the latch 207 and lock the door 205 as shown in FIG. 15b. The latched door 205 in the closed condition will prevent the unwanted animal from entering through the door 205.

The door assembly, in a preferred embodiment, will be a subcomponent to a device such as a kitty litter box 202 that has an opening 204 in the box. The assembly 200 will have mounting brackets 181, 182, 183, 184 for mounting the door assembly to the kitty litter box opening 204. Therefore, it is understood that the present invention allows for a pet owner who already has a kitty litter box 202 to upgrade the box by adding the door assembly 200 and will not have to purchase an entirely new kitty litter box, as discussed above with respect to FIGS. 13a-d. The door assembly 200 may have other means of attaching the frame 201 to a pre-existing opening of a litter box such as clamps, hooks, Velcro, screws or other fasteners so that the frame 201 may be easily attached to the front of an existing litter box 202. These door assemblies 200 may be manufactured in various sizes so that they can fit a multitude of litter boxes and openings in each litter box so that the door 205 can be easily opened and closed. As discussed above, in an alternate embodiment, the sensor 203 may activate a motor which actuates the door so that it automatically opens or closes depending on the presence of the unwanted animal.

In an embodiment, the door 205 is hingedly attached at the top 177 of the frame 201. Latches 181, 182, 183 and 184 are provided around the frame 201. As shown in FIG. 14a, the latches 181, 182, 183, 184 are in the extended position and mount the frame 201 to an existing litter box 202.

FIG. 14b is a section view of the latch 184, but shown in a retracted position with the screw 186 retracted into the latch clip 187 and the head 188 is not attached to the frame 201.

FIG. 14c is an embodiment showing latch body 190 having a pin 186 and head 188 which is in the retracted position disengaged from the latch clip 187 prior to installation of the door assembly 200. A U-shaped clip 187 is slid over the frame 201 by threading the screw 186 into an aperture 189 of the clip 187. As the screw is attached to the frame 201, by rotating the head 188, the screw 186 pushes the clip 187 outward against the litter box housing 202 in order to mount the door assembly 200 within the housing 202. By adjusting each of the latches 181, 182, 183, 184, the frame 201 can be centered in the opening 204 of the existing litter box 202.

It is to be understood that many alternate forms of detectors or sensors may be used for the present invention, described for FIGS. 1-15b above. For example, the device 10 may include use recognition software; a bar code on the pet's collar and scanning circuitry on the dish to scan the collar; radio signal transmission means such RFID to communicate between lid and collar; a weight sensor pad in front of the device in order to further supplement the location data provided to the device about the location of the wanted or unwanted animal; use of a light sensor to locate the wanted or unwanted animal; use of a movement sensor to locate the wanted or unwanted animal; use of a temperature sensor to locate the wanted or unwanted animal; or use of magnets on the animal or animal's collar to help locate the wanted or unwanted animal. As well, multiple transmitters 30 and collars 32 may be provided so that a household with many pets can equip each of the many unwanted animals with a transmitter 30.

In a further alternate embodiment, the transmitter in the collar 32 of the pet may be replaced with a wire. The power source in the collar 32 will provide a current in the wire which generates an electromagnetic field. The sensor in the device 10 may include a voltage sensor that senses the electromagnetic field provided by the collar 32 in order to activate the device 10. For example, the sensor may be tuned to react to a 5 Volt current source of the collar in order to activate the device 10 to prevent the unwanted animal from accessing the device. In a further embodiment, a different collar may be provided on another animal (either another unwanted animal or a wanted animal) that carries a ten (10) Volt current. The sensor of the device 10 may be a voltage detector that is programmed to activate the device in a different manner when the ten (10) Volt current is sensed; as opposed to the 5 Volt current of the other animal. For example, if the animal with the 10 Volt current is a wanted animal, the device 10 may remain open and allow the animal with the 10 Volt collar to have access. It is also possible to use different current, voltage or frequency levels emitted by the wire in the collar 32 to activate the sensor of the device 10. In a further embodiment, the wire may also be connected to a vibrating device or other method of cueing the animal. Thus, when the animal approaches the device 10, the device sensor reacts to the electromagnetic field of the wire and triggers the vibrator in the collar 32 to activate in order to signal to the animal it should not approach the device, such as a food dish 144.

It is to be understood that many alternate forms of means of preventing access to the device may be provided by the present invention, described for FIGS. 1-15b above. For example, the device 10 may spray a chemical, scent or water at the unwanted animal; the device may make a loud sound, such as a clap, a high pitched whistle, recorded owners voice saying “no;” the device may activate a shock collar; the device may actuate the collar to buzz; or the device may sound an alarm or flash lights to notify the owners.

It should be understood that the cover or door discussed above with respect to the device in FIGS. 1-15b may have many alternate constructions and mechanisms. For example, the cover or door may include a first half and a second half and each half is pivotally mounted on the housing, so that when the first half abuts the second half the device is completely covered and in the closed condition; each half is semi-spherical; each half is hinged at a midline and in the closed position each half extends from the midline from the side of the housing; each half is hinged at an edge in the closed position the edge is adjacent a side of the housing; the cover includes a first half and a second half and each half is slidable to a closed position where each half is abutting the other half and encloses the housing; the cover includes a first half and a second half and each half includes articulated sections that are deformed in an open position; the cover includes a first and second half each having a dome shape; the cover forms an iris-like interleaved lid that is supported at an opening of the housing; the motor actuates the device between an open and closed condition; the device is mounted to a motorized track that moves the device to the closed condition under the cover and the open condition disposed away from the cover; the cover is disc shaped and includes a pivot point upon which this disc rotates between the open and closed condition; the cover is formed of a pair of semicircular shaped discs which each include a pivot point located on opposite sides of the device and upon rotation of the halves on each of the pivot points, the halves abut each other and enclose the device; the lid is a pivotally attached disc which pivots between the opened and closed position; the device includes a column having a plate mounted therein and the plate is actuatable between a lower and upper position accessible to the animal; the device is mounted on a platform that raises and lowers the device in order to come in contact with the cover in order to close the device; the device is a cylinder with an open hole and the cylinder rotates in order to align the hole with the device to provide access to the animal; the cover includes two halves that slide on top of one another and overlap horizontally in order to close the device; a threaded shaft is provided along the longitudinal axis of the device and has the cover mounted thereon and inserted through a threaded hole of the cover so that upon rotation of the shaft the cover will ride along the threaded shaft between the open and closed condition; the device is a box having a horizontally sliding front door which exposes the device mounted therein; the cover is a flat accordion door that folds between the open and closed condition; the device includes a cylinder that surrounds the device and they cylinder is moveable between a lowered and elevated position in which to conceal the device and prevent access by the animal; the lid is suspended by a wire and the actuation of the motor causes the wire to lower the lid to the closed condition; the cover is formed of a flexible material which is wound in a roll adjacent an opening at the top of the device and may be unrolled to cover the opening in order to provide the cover in the closed condition; the cover is formed of slats which slide to block the opening of the device; the cover forms a V shape extended above the top of the device in the open condition and collapses flat in order to cover the opening and provide the cover in the closed condition; the device is provided within a box having a first end and a second end and a hole formed in the first end and the device is moveable between the first end and the second end and at the first end the device is adjacent the hole in the box so that access is provided to an animal and provides the cover in the open condition; the device includes a netting for receiving food therein and upon actuation of the motor the netting is raised out of the device to provide access to the animal in the open condition; the device includes a cylinder mounted within an outer cylinder having a hole therein and the device may rotate within the outer cylinder in order to align the opening of the device with the opening of the outer cylinder in the open condition; the cover includes two halves hinged at a middle area of the device and in the open condition the halves extend upward at the center in order to bisect the device; the cover includes a single dome that rotates over the device in order to provide the closed condition; three segments provide for the cover and slide between the open and closed condition; the cover is oriented at the top of the device at a skewed angle and the cover slides upwardly to enclose the top of the device; the cover includes a single hinged door that has a generally vertical orientation in a closed position and a generally horizontal orientation in the open condition; the motor actuates a latch placed adjacent the door in order to lock the door in the closed condition; the motor actuates the door to move between the opened and closed condition.

The matter set forth in the foregoing description and accompanying descriptions if offered by way of illustration only and not as a limitation. While particular embodiments have been shown described, it will be obvious to those skilled in the art that changes and modifications may be made without departing from the broad aspects of applicant's contribution. The actual scope of the protection sought is intended to be defined in the following claims when viewed in their perspective when based on the prior art.

1. A system for preventing access to a device by an unwanted animal, the system comprising:
a device including a housing having a cover, a storage area, a motor and a sensor;
a transmitter placed on the unwanted animal; and
the sensor responding to the transmitter when it is in close proximity to the device to activate the motor in order to actuate the cover to prevent access by the unwanted animal.

2. The system of claim 1 wherein the device is a pet dish for holding pet food and the cover completely encloses an opening of the dish so that an animal cannot eat food in the storage area of the dish.

3. The system of claim 1 wherein the device is a litter box for containing pet feces in the storage area and the cover includes a door that covers an opening of the box.

4. The system of claim 3 wherein the door includes a lock that is actuated by the motor in order to lock the door to prevent access by the unwanted animal.

5. The system of claim 1 wherein the motor actuates the cover so that it moves from an open condition to a closed condition.

6. The system of claim 1 wherein the motor actuates a latch to provide the cover in an open and closed condition.

7. The system of claim 6 wherein the cover includes a first half and a second half and each half is pivotally mounted on the housing, so that when the first half abuts the second half the device is completely covered and in the closed condition.

8. The system of claim 7 wherein each half is semi-spherical.

9. The system of claim 7 wherein each half is hinged at a midline and in the closed position each half extends from the midline from the side of the housing.

10. The system of claim 7 wherein each half is hinged at an edge in the closed position the edge is adjacent to a side of the housing.

11. The system of claim 6 wherein the cover includes a first half and a second half and each half is slidable to a closed position where each half is abutting the other half and encloses the housing.

12. The system of claim 6 wherein the cover includes a first half and a second half and each half includes articulated sections that are deformed in an open position.

13. The system of claim 6 wherein the cover includes a first and second half each having a dome shape.

14. The system of claim 6 wherein the cover forms an iris-like interleaved lid that is supported at an opening of the housing.

15. The system of claim 1 wherein the motor actuates the device between an open and closed condition.

16. The system of claim 15 wherein the device is mounted to a motorized track that moves the device to the closed condition under the cover and the open condition disposed away from the cover.

17. The system of claim 6 wherein the cover is disc shaped and includes a pivot point upon which this disc rotates between the open and closed condition.

18. The system of claim 6 wherein the cover is formed of a pair of semicircular shaped discs which each include a pivot point located on opposite sides of the device and upon rotation of the halves on each of the pivot points, the halves abut each other and enclose the device.

19. The system of claim 6 wherein the lid is a pivotally attached disc which pivots between the opened and closed position.

20. The system of claim 6 wherein the device includes a column having a plate mounted therein and the plate is actuatable between a lower and upper position accessible to the animal.

21. The system of claim 6 wherein the device is mounted on a platform that raises and lowers the device in order to come in contact with the cover in order to close the device.

22. The system of claim 6 wherein the device is a cylinder with an open hole and the cylinder rotates in order to align the hole with the device to provide access to the animal.

23. The system of claim 6 wherein the cover includes two halves that slide on top of one another and overlap horizontally in order to close the device.

24. The system of claim 6 wherein a threaded shaft is provided along the longitudinal axis of the device and has the cover mounted thereon and inserted through a threaded hole of the cover so that upon rotation of the shaft the cover will ride along the threaded shaft between the open and closed condition.

25. The system of claim 6 wherein the device is a box having a horizontally sliding front door which exposes the device mounted therein.

26. The system of claim 6 wherein the cover is a flat accordion door that folds between the open and closed condition.

27. The system of claim 6 wherein the device includes a cylinder that surrounds the device and they cylinder is moveable between a lowered and elevated position in which to conceal the device and prevent access by the animal.

28. The system of claim 6 wherein the lid is suspended by a wire and the actuation of the motor causes the wire to lower the lid to the closed condition.

29. The system of claim 6 wherein the cover is formed of a flexible material which is wound in a roll adjacent an opening at the top of the device and may be unrolled to cover the opening in order to provide the cover in the closed condition.

30. The system of claim 6 wherein the cover is formed of slats which slide to block the opening of the device.

31. The system of claim 6 wherein the cover forms a V shape extended above the top of the device in the open condition and collapses flat in order to cover the opening and provide the cover in the closed condition.

32. The system of claim 6 wherein the device is provided within a box having a first end and a second end and a hole formed in the first end and the device is moveable between the first end and the second end and at the first end the device is adjacent the hole in the box so that access is provided to an animal and provides the cover in the open condition.

33. The system of claim 6 wherein the device includes a netting for receiving food therein and upon actuation of the motor the netting is raised out of the device to prevent access to the animal in the closed condition.

34. The system of claim 6 wherein the device includes a cylinder mounted within an outer cylinder having a hole therein and the device may rotate within the outer cylinder in order to align the opening of the device with the opening of the outer cylinder in the open condition.

35. The system of claim 6 wherein the cover includes two halves hinged at a middle area of the device and in the open condition the halves extend upward at the center in order to bisect the device.

36. The system of claim 6 wherein the cover includes a single dome that rotates over the device in order to provide the closed condition.

37. The system of claim 6 wherein three segments provide for the cover and slide between the open and closed condition.

38. The system of claim 6 wherein the cover is oriented at the top of the device at a skewed angle and the cover slides upwardly to enclose the top of the device.

39. The system of claim 6 wherein the cover includes a single hinged door that has a generally vertical orientation in a closed position and a generally horizontal orientation in the open condition.

40. The system of claim 6 wherein the motor actuates a latch placed adjacent the door in order to lock the door in the closed condition.

41. The system of claim 6 wherein the motor actuates the door to move between the opened and closed condition.

42. The system of claim 1 wherein the unwanted animal is a dog.

43. The system of claim 1 wherein the unwanted animal is a cat.

44. The system of claim 1 wherein the unwanted animal is livestock.

45. The system of claim 1 wherein the wanted animal is a cat and the device remains in the open condition in order to treat bulimia of the cat.

46. The system of claim 1 wherein the sensor includes a receiver for receiving a signal from the transmitter and a circuit for activating the motor in order to activate the cover.

47. The system of claim 1 wherein the device includes a timer for deactivating the actuator and allowing the device to be opened and accessed by the wanted animal.

48. The system of claim 1 wherein the device is a subcomponent of a larger device and may be attached to the larger device in order to prevent access to the larger device.

49. The system of claim 48 wherein the device is a door assembly that may be attached to a litter box in order to modify the litter box so that it can prevent access by an unwanted animal.

50. The system of claim 48 wherein the device is a cover assembly that may be attached to feeding dish in order to modify the feeding dish so that it can prevent access by an unwanted animal.

51. A method of altering an animal's behavior comprising the steps of:
providing a device with a cover that has an open and closed condition, a sensor that activates the cover and a transmitter for a first animal;
providing the device in the open condition where the cover does not block access and allows a second animal to access the device;
activating the sensor upon receipt of a signal from the first animal's transmitter when the first animal is in close proximity to the sensor;
actuating the cover to the closed condition by the sensor when the first animal is in the close proximity;
providing a cue for the first animal, the cue occurring due to the actuation of the cover from the open condition to the closed condition in order to prevent access to the first animal;
causing the first animal to move away from the device due to the cue; and
actuating the cover to the open condition by activation of the sensor when the first animal's transmitter exits the close proximity.

52. The method of claim 51 wherein the cue is a visual cue caused by the closing of the cover.

53. The method of claim 51 wherein the cue is an audible stimulus caused by the closing of the cover.

54. The method of claim 51 wherein the cue is an audible stimulus caused by a motor of the device activated by the sensor to close the cover.

55. The method of claim 51 wherein the cue is duplicative of a previously provided cue.

56. The method of claim 55 wherein the previously provided cue is the animal caretaker's voice command directing the animal's behavior and the cue is a recording of the animal caretaker's voice command.

57. The method of claim 51 wherein the actuation of the device to the open condition provides a constant positive visual cue that reinforces a second animal's good behavior.

58. The method of claim 51 wherein the device is a pet dish for holding pet food.

59. The method of claim 51 wherein the device is a litter box for holding pet feces.

60. The method of claim 51 further comprising the step of allowing the second animal to have free access to the device that will remain in the open condition, so long as the first animal is not in the close proximity.

61. The method of claim 51 further comprising the steps of:
providing a transmitter for the second animal; and
activating the sensor upon receipt of a signal from the second animal's transmitter in order to maintain the cover in the open condition, when the first animal is in close proximity.

62. The method of claim 51 wherein the cover includes:
a first half and a second half that each rotate toward each other; and
providing a clam shell like assembly and upon abutment of the first half against the second half so that the cover is in the closed condition.

63. The method of claim 51 wherein the cover includes a door having a lock and the method further comprising the steps of:
activating the lock by triggering of the sensor by the transmitter being in the close proximity; and
locking the door so that the device may not be accessed by the first animal.

64. The method of claim 51 wherein the cue is a negative reinforcement based stimulus that trains the first animal to keep away from the device.

65. The method of claim 51 wherein repeated attempts by the first animal to access the device acts to modify the behavior of the first animal in order to cease its attempts to access the device despite the actuation of the cover.

66. A method for deterring an animal from accessing a device comprising the steps of:
providing a device having a receiver and a cover;
attaching a transmitter to an animal;
generating a signal from the transmitter to the receiver; and
actuating the cover in response to the receiver being triggered by the transmitter signal.

67. The method of claim 66 wherein the actuation of the cover further comprises the step of locking the cover in a closed condition.

68. The method of claim 66 wherein the actuation of the cover further comprises the step of moving the cover from an open to a closed condition.

69. A method for treating a bulimic animal comprising the steps of:
providing a food dish having a cover and a sensor, the dish for holding food for a first animal that is bulimic;
placing a transmitter on a second animal;
triggering the sensor to actuate the cover to move to a closed condition only when the second animal's transmitter is signaling the sensor; and
maintaining the cover in an open condition so that the bulimic animal's food is visible when the second animal is not present.

70. The method of claim 69 wherein the open condition of the cover provides a constant positive cue that reinforces the bulimic animal's good behavior.
